(19) United States
(12) Patent Application Publication
(10) Pub. No.: US 2002/0046236 A1
(43) Pub. Date: Apr. 18, 2002

(54) Network service providing system

(75) Inventors: Yoichi Morimoto, Zama-shi (JP); Yoshio Noda, Zama-shi (JP); Hiroto Toshida, Zama-shi (JP); Shinichi Matsuda, Zama-shi (JP); Hiroyuki Hamawaki, Zama-shi (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Computer Engineering & Consulting Ltd., Kanagawa (JP)

(21) Appl. No.: 09/866,980

(22) Filed: May 29, 2001

(30) Foreign Application Priority Data
May 29, 2000 (JP) 2000-158167

(51) Int. Cl. G06F 15/16

(52) U.S. Cl. 709/203; 709/219

(57) ABSTRACT

A service providing system which securely prevents application servers, where works are conducted, from illegal accesses. The system has a network, a service provider system for providing a service via the “net” work, a client who requests a service to the service provider system; the service provider system has a service server being connected to the network and one or more application servers which are connected to the network via the service server.

### BACKGROUND OF THE INVENTION

1) Field of the Invention

The present invention relates to a network service providing system using a computer network, such as an Internet.

2) Related Art

Recently, many services providing systems are realized on a computer network, such as an Internet, using a wide area information system, so called WWW (World Wide Web). FIG. 1 shows an example of the construction of such a conventional service providing system.

Referring to FIG. 1, the conventional service providing system comprises a computer system 10 at a client side, an Internet 20, and a computer system 30 at a service provider side. The computer system 10 at a client side comprises a plurality of terminals, such as personal computers, 11-1 to 11-n, which are individually connected to the Internet 20. On the other hand, the computer system 30 at a provider side comprises sites 31-1 to 31-n that are held on the Internet 20. Each of the sites 31-1 to 31-n possesses its own URL address, so that each client can freely access to a desired site through the Internet 20 by designating the URL address thereof. Each site 31 has an application server 32, which comprises, for instance, a mail server or a web server, and also has an illegal access-protecting server 33, such as a fire wall server and a virus check server. These servers are connected to each other with the aid of a LAN system. In the conventional service providing system, the illegal access protecting server 33 is provided in each site in an individual manner.

In case that, for instance, the client 11-1 wishes to access to the web server 32b on the site 31-1 to obtain information mentioned on the web page thereof, the client 11-1 sends a request to the Internet 20 designating the URL address (http://www.abc.co.jp) of the site 31-1. This request is delivered to the designated site 31-1 and then becomes in a condition accessible to the desired web server 32b after checked by the illegal access protecting server 33, such as a firewall. Then the web server 32b responds to the request to transfer the necessary data to the client; the data is mentioned on the screen of the client's terminal 11-1; the client can then obtain the service, which is offered by the web server 32b.

While, in case that the client 11-2 wishes to send an e-mail to the site 31-2, the client 11-2 sends a request for sending an e-mail to the Internet 20, designating the mail address of the site 31-2 (aaa@xyz.co.jp). This request is delivered to the designated site 31-2 and then becomes to be accessible to the desired mail server 32c after checked by the illegal access protecting server 33, such as a virus checker.

In this manner, according to the conventional network service system, the computer system 10 at the client side and the sites 31-1 to 31-n at the system 30 of the service provider side are connected to the network 20 directly, so that the application servers of each site 31-1 to 31-n at the service provider side 30 directly respond to the access from the client side 10. Therefore, the application servers 32 at the service provider side 30 are sometimes directly damaged by illegal accesses from clients; for instance, the web page is illegally altered by a hacker or the application servers 32 are broken into by a computer virus.

In the conventional service system, in order to prevent such damage, an illegal access protection server, such as a firewall, or an anti-virus server is provided at each site in an individual manner. However, such a protection server system is very expensive and a great amount of labor work is necessary to establish the system. And therefore, every site cannot have a highly qualified protection server. Alternatively, even if such a highly qualified protection server could be established in each site, the cost for providing the service to the client would be very expensive.

Further, in order to provide services by application servers 32 in each site, it is necessary for each site to have assistant servers, such as data backup server, data translation server, etc. for supporting the works conducted in the application servers 32. However, in the conventional system, such assistant servers are provided at each site, individually. Therefore, the equipment for the assistant serving and works conducted in the assistant servers are overlapped among the sites although the equipment or the works can be commonly used to these sites; such a situation also makes the cost for providing the service expensive.

Furthermore, the illegal accesses protection server or the assistant servers for supporting the works conducted in the application servers at each site of the conventional system include an expensive server system, such as a firewall; such a server is normally provided only one for one site, because of its expensive price; therefore, if the only illegal accesses protection server goes out of function, the application server becomes unconnectable immediately.

### SUMMARY OF THE INVENTION

The present invention has for its purpose to solve the above-mentioned problem; the system comprises a “net” work, a computer system at a service provider side for providing a service via said “net” work, a computer system at a client side for requesting a service to the computer system at the service provider side, wherein said computer system at the service provider side comprises a service server which is connected to said “net” work directly, and at least one application server which is connected to said “net” work via said service server.

According to the invention, the application servers for providing services are connected to the network via the service server; in other words, the application servers are kept isolated from the network with the service server. Therefore, the client cannot access the application servers directly, so that the application servers can be protected from illegal accesses which alter the data held in the application servers. According to the system of the present invention, even if the client tries to illegally access to the application servers, intending to damage them, it would result for the client to illegally access not to the application server but the service server, so that the application servers can be kept safe.

The service system according to the invention has an aspect in that the service server manages the application servers in an individual manner; that is to say, when the client requests a service to the network designating the address of one of the application servers, the service server corresponds to the request from the client to the application server, to send the request from the client to the service server and then deliver the service obtained from the service server to the client in its own manner.

In this manner, according to the present invention, the service server manages the application server individually. For instance, when the client requires data mentioned on a web page on the Internet, designating its address of the web page, or when the client requests to send data to a mail server, designating an electric mail address of the mail server, the service server receives the request from the client and sends the requests to the relevant application server under management of the service server itself. In this system, when it is necessary to send data from the application server to the client, the data is sent to the client via the service server. That is to say, the client's request and the relevant application server are corresponded together in the service server by its own manner, so that the application servers can be safely kept from illegal accesses. On the other hand, since the process to be done at the client side, i.e. to designate an address on the network to request a service, is the same as that conducted in the conventional system, it looks for the client as if the client accessed the application server directly. Therefore, the client can obtain all services without changing the process which has been provided to for the service in the conventional system.

In the service system according to the invention, it is preferred that the application servers and the service server are connected together by dedicated lines or ISDN (Integrated Services Digital Network) which is arranged to allow only the receipt of data from clients that have requested numbers.

By using dedicated lines or ISDN having the special arrangements, the quality of the circuits becomes high, and it becomes impossible to directly access to the application server from the outside, so that the safety of the application server is secured and the application server can be well protected.

Furthermore, the service system according to the invention has another aspect in that the service server has a function to support the works conducted in the application servers.

According to this constitution, the functions, which have been established at each site separately in the conventional system, can be carried out at a single server system, i.e. at the service server, so that the cost for providing a service in the network providing service system can be made cheaper.

It should be noted that the application server(s) also could be a client of the network service providing system according to the present invention.

As the network, Internet, WAN, LAN, etc. can be preferably used.

The above-mentioned function to support the works of the application server includes: at least one selected from a group consisting of an illegal access protecting function, a virus checking function, a data cleaning function, a data translation function, a data storing function, a data value added distribution function, and a data backup function. Further, according to the invention, it may be possible to arrange such that the service server conducts the function(s) which is (are) commonly used among the application servers; the function is at least one selected from a group consisting of an illegal access protecting function, a virus checking function, a data cleaning function, a data translation function, a data storing function, a data value added distribution function, a data backup function, a data exchange history among the application servers storing function, a dealing data protocol translating function, and an analyzing result from a data warehouse distribution function.

Furthermore, it is preferred to have a plurality of the service servers so as to have a data back up function and/or a load distribution function between the service servers.

According to this arrangement, even if one of the service servers becomes out of order by an illegal access, the application servers can be driven by another service server.

The second invention of the present application relates to a service providing method, where at least one application server having a service providing function is connected to a service server via a dedicated line or an ISDN which is arranged to receive accesses only from a client which has a special number, the service server is connected to a network and a service is obtained from the application server according to a request from the client, and the service is provided to the client via the service server.

In this manner, according to the second invention, since the application server is connected to the service server via a dedicated line or an ISDN having a special arrangement, it becomes impossible to directly access to the application servers from the outside. Therefore, even if an illegal access comes from the outside, the illegal access can arrive only to the service server, so that the application servers are kept safe.

In a preferred embodiment, the service server manages the dedicated lines (or ISDN) which connects the application servers and the service server; it is arranged such that when the client requests a service on the network designating the address of the application server, the service server makes a correspondence between the designated application server and the relevant dedicated line (or ISDN) to provide the service desired by the client via the service server; thereby the real address of the application server is hid for the client so that the safety of the application server is increased.

Furthermore, the service providing method according to the second invention has an aspect in that the service server has a function to support the works conducted in the application server(s) and the application server(s) uses the supporting function. Moreover, the service server has at least a firewall as the application server supporting function; thereby the cost for providing a service can be decreased.

### BRIEF DESCRIPTION OF THE DRAWINGS

FIG. 1 is a schematic view showing a construction of the conventional network service providing system.

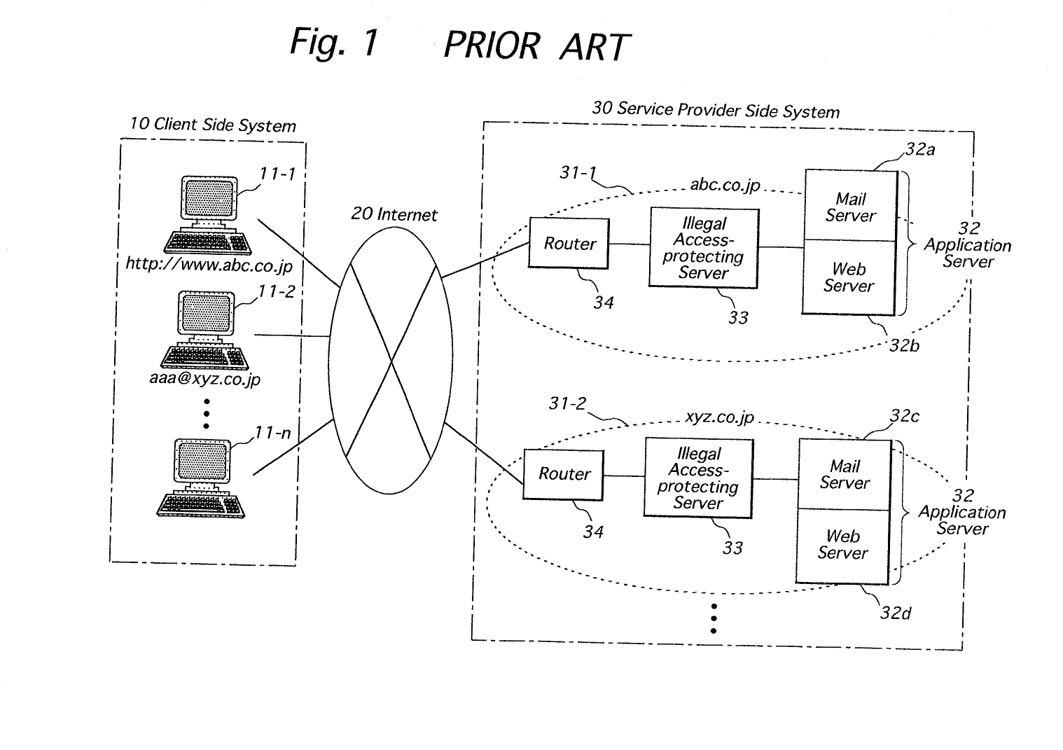

FIG. 2 is a schematic view depicting a construction of the network service providing system according to the first embodiment of the present invention.

FIG. 3 is a schematic view for explaining the service conducted in the system depicted in FIG. 2.

FIG. 4 is a schematic view illustrating a construction of the network service providing system according to the second embodiment of the present invention.

FIG. 5 is a schematic view representing a construction of the network service providing system according to the third embodiment of the present invention.

### DETAILED EXPLANATION OF THE PREFERRED EMBODIMENTS

Preferred embodiments of a service system according to the present invention will be explained in detail, referring to the attached drawings.

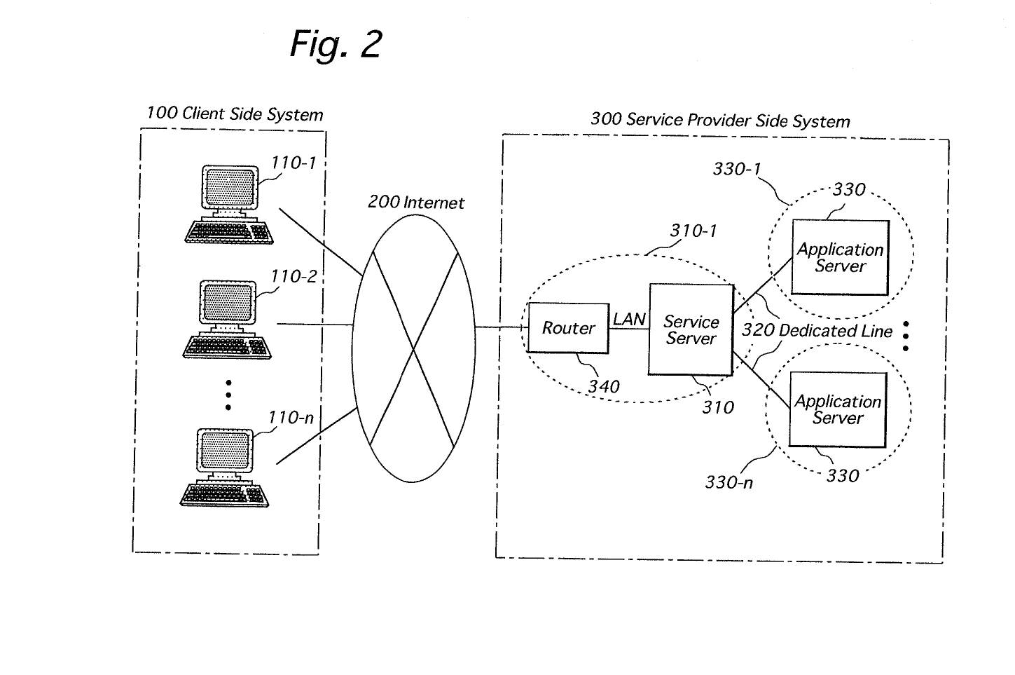

FIG. 2 is a schematic view showing a construction of a service providing system according to the present invention. The system comprises a computer system at the client side 100, a network 200, such as an Internet, a computer system at the service provider side 300. The Computer system 100 comprises a plurality of terminals 110-1 to 110-n, each of them is connected to the Internet 200. The computer system at the service provider side 300 comprises a service server 310, which is directly connected to the Internet 200 and an application servers 330, which are connected to the service server 310 via dedicated lines 320-a to 320-n, respectively. In this embodiment, two application servers 330 are mentioned, however only one application server, or three or more application servers may be connected to the service server 310.

The service server 310 and the application servers 330 hold sites 310-1, 330-1 to 330-n, respectively; each site has its own URL address. However, accesses to the application server sites 330-1 to 330-n are collectively received at the service server site. As stated below, when one of the clients accesses to the Internet 200, designating an URL address of one of the application servers 330, the service server 310 replaces the URL address accessed by the client to the address of the corresponding dedicated line which connects the service server 10 to the relevant application server to mediate the access.

The application server 330 provides plural kinds of services, for instance, a web server opening home pages to the public or holding a shopping mall, or a mail server to transfer electronic mails.

At the service server 310, many functions are carried out, for instance, an illegal access preventing server such as a fire wall, a virus check server, or a web mediating server for transferring electronic mails between the client 100 and the application server 330; these functions are not conducted in the application servers 330. Further, the service server 310 may have functions to support the works conducted in the application server 330. As such functions, for instance, a data cleaning function, a data converting function, a data supplementing function, a data value-added distributing function, and a data back up function can be recited.

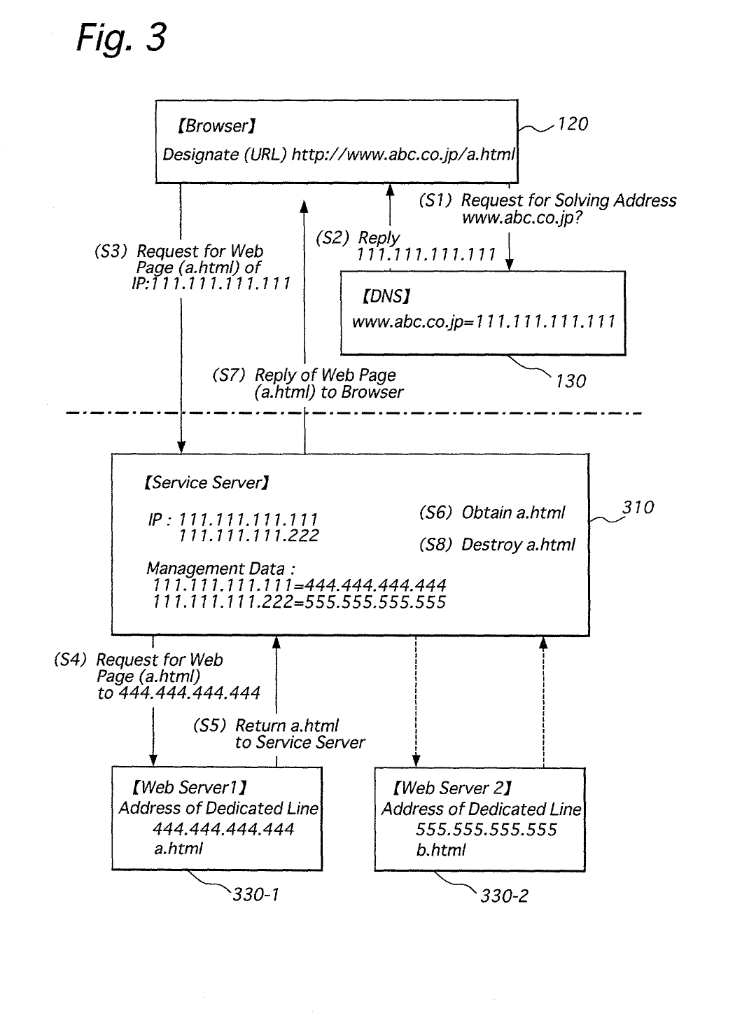

FIG. 3 shows concrete processes for providing a service from the service provider side system 300 to the client side system 100.

First, the browser 120 at the client side 100 send a request to the DNS (Domain Name System) 130 to solve the address concerning an URL (www.abc.co.jp) of the domain to which the client wishes to access (Step S1); then the browser 120 obtains an IP address, which corresponds to the relevant domain, from the DNS 130 (Step S2). Then, the browser 120 requests a web page (a.html) to the Port 80 of the IP address (111.111.111.111) on the Internet 200 (Step 3).

The service server 310 keeps the IP addresses (111.111.111.111 and 111.111.111.222) of the application servers 330-1 and 330-2, and the management addresses for the application servers 330-1 and 330-2 (i.e. 444.444.444.444 and 555.555.555.555), which are under the management of the service server 310. In reply to the request from the browser 120, the service server 310 replaces the IP address (111.111.111.111) of the application server 310-1, which is required by the browser 120, to the relevant management address (444.444.444.444), which is individually managed by the service server 310; then the service server 310 sends the request to the relevant application server 330-1. In this embodiment, the address management of the application servers 330 is carried out by using the addresses of the dedicated lines 320-1 to 320-n which connect the service server 310 and the application servers 330-1 to 330-n, respectively.

More concretely, the service server 310 works in such a way that: the request for the IP address (111.111.111.111) from the browser 120 on the Internet 200 is received, an address of the dedicated line (444.444.444.444) of the application server relevant to the IP address (111.111.111.111) is sought, and a request for the web page (a.html) is sent to the Port 80 of this dedicated line 320-1 (step S4). In response to the request, the web server 330, which is connected to the dedicated line 320-1 (444.444.444.444), returns the web page, i.e. (a.html), to the service server 310 (Step S5). The service server 310 obtains the web page (a.html) (Step S6), returns it to the browser 120 (Step S7) and then destroys the web page (a.html) (Step S8).

In the embodiment shown in FIG. 3, only two web servers 330-1 and 330-2 are shown as an example, however, only one web server or three or more web servers may be arranged. Further, the other kind of servers, for instance, a mail server, etc. may be used for the web server.

Further, it may be possible to arrange that the access from the browser 120 to the service server 310 is conducted by using a substitution server. In this case, the browser requests the web page on the Internet 200, designating the IP address of the substitution server; then the substitution server sends a request for solving the address of the web page to the DNS, receives the answer from the DNS (Domain Name System) for solving the address, sends a request for the web page to the service server 310 on the Internet 200, receives the web page returned from the service server 310, and returns the web page to the browser 120. The access finishes when the substitution server returns the response from the web page (a.html) to the browser 120.

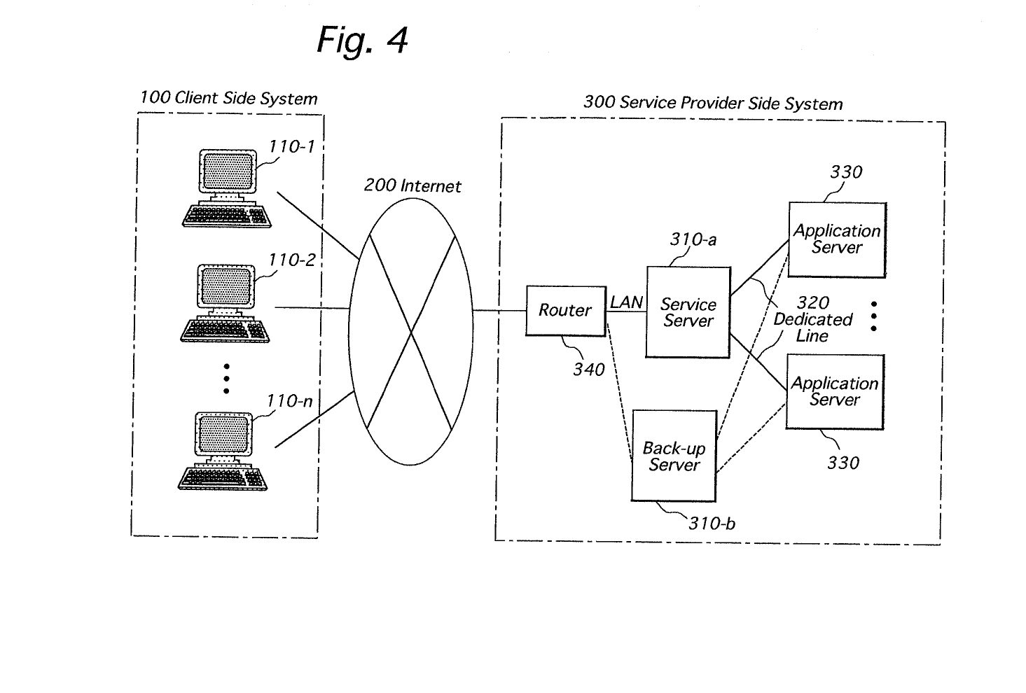

FIG. 4 shows a construction of the second embodiment of the system according to the present invention. As shown in FIG. 4, in the second embodiment, two service servers 310-a and 310-b are provided in the system 300 at the service provider side; one of which works as a main service server 310-a and the other one backs-up the main service server 310-a in case the main service server becomes out of order. The two service servers 310-a and 310-b may have the same functions, or they may be arranged such that the back-up service server 310-b has only important functions, for instance, the fire wall function. It may also be arranged such that the two service servers contribute different functions in order to make the load applied on one service server lighter. In this case, three or more service servers may be used.

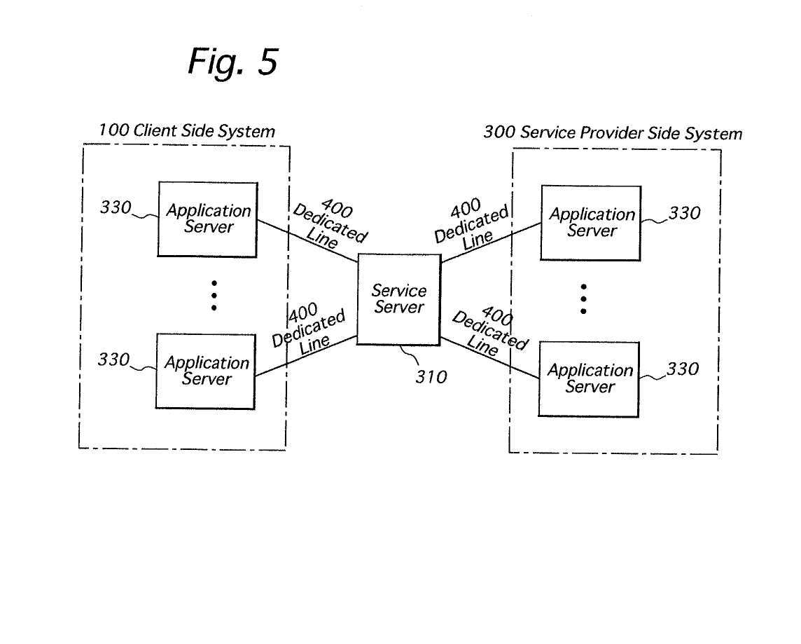

FIG. 5 shows a construction of the third embodiment of the system according to the invention. In the third embodiment, dedicated lines 400 are used as a network to connect the client side to the service provider side, so that the system is constituted to a certain limited area. In the third embodiment, some of the application servers 330 act as the client side system 100 in the first and second embodiments. In the same manner to the first embodiment, a fire wall is provided in the service server 310 to prevent illegal accesses; the service server 310 may also have application support functions such as a data cleaning function, a data converting function, a data storing function, a data value-added distributing function, a backup function, etc. Furthermore, it may be possible to arrange such that the service server 310 provides special supporting functions which are necessary to provide services among the application servers, for instance, a function to store a data exchange history, a function to convert the protocol of dealing data, and to distribute a dataware house analyzing result to the transacted application server. Such an arrangement reduces the running cost of the system.

In the network providing service system according to the present invention, the application servers, which actually conduct the business, are connected to the network via the service server so that the application servers are isolated from the network. Therefore, in case that an illegal access comes from the client side, it does not reach to the applicant servers, resulting only in the influence to the service server, and therefore the application servers can be protected from illegal accesses.

Further, the service server is arranged to have an illegal access preventing function or a business supporting function for the application servers. Therefore, it becomes possible that the application servers connected to the service server commonly own the expensive systems such as a fire wall system, so that the cost of providing the services can be reduced.

Furthermore, according to the invention, the same services to those in the conventional system can be obtained by the expensive server such as a fire wall, which is provided in the service server, so that the cost for providing services can be reduced. Moreover, a highly qualified system can be constructed if two or more service servers are provided in the system.

What is claimed is:

1. A service providing system comprising a network, at least one client being connected to said network, a system at service provider side for providing services to said client via said net work, wherein said system at service provider side comprises a service server being connected to said network and at least one application server for providing services; and wherein a request by the client is delivered via said service server and services provided by the application server are returned to the client via the service server.

2. A service providing system according to claim 1, wherein said service server manages addresses of said application servers individually; wherein when said client sends a request for obtaining a service from the application servers designating an address of one of the application servers on said network, said service server makes up a correspondence between the request and the relevant application server, and then said service server obtains the service from the relevant application server and sends it to the client.

3. A service providing system according to claim 1, wherein said application servers and said service server are connected together via ISDN where only designations from dedicated lines or from particular numbers are recognized.

4. A service providing system according to claim 1, wherein said service server has at least one function to support the work conducted in said application servers.

5. A service providing system according to claim 1, wherein said network is Internet, Intranet, WAN or LAN.

6. A service providing system according to claim 1, wherein one or more of said application servers constitute a client.

7. A service providing system according to claim 6, wherein said net work is WAN or LAN.

8. A service providing system according to claim 5, wherein said function for supporting the work conducted in said application servers includes at least one selected from the group consisting of an illegal access preventing function, a virus checking function, a data cleaning function, a data converting function, a data storing function, a data value added distributing function, and a data backup function.

9. A service providing system according to claim 6, wherein said function for supporting the work conducted in said application servers includes at least one selected from the group consisting of an illegal access preventing function, a virus checking function, a data cleaning function, a data converting function, a data storing function, a data value added distributing function, a data backup function, a data exchange history storing function between said application servers, a data protocol conversion function, and a datawear house analyzing result distributing function.

10. A service providing system according to claim 1, wherein a plurality of service servers are provided and at least one of them backs-up the others.

11. A service providing system according to claim 1, wherein a plurality of service servers are provided so that a load of the system is distributed to the plurality of service servers.

12. A service providing method comprising steps:
connecting application servers having a service providing function to a service server via ISDN where only destination from dedicated lines or particular numbers is recognized;
connecting said service server to a network; and
providing a service from said application server to clients, which are connected to said network, via said service server.

13. A service providing method according to claim 12, wherein said service server manages said dedicated lines or ISDN which connects said application server and said service server, and wherein when one of said clients requests a service designating an address of said application server on said network, said service server makes up a correspondence between said request and the relevant application server to provide the required service to said client.

14. A service providing method according to claim 12, wherein said service server has a function to support the work conducted in said application server, and wherein said application server uses the supporting function.

15. A service providing method according to claim 14, wherein said service server has at least a fire wall function for said application server supporting function.
